(19) United States
(12) Patent Application Publication
(10) Pub. No.: US 2008/0093484 A1
(43) Pub. Date: Apr. 24, 2008

(54) Injection Nozzle

(76) Inventors: Wolfgang Stoecklein, Stuttgart (DE); Andreas Rau, Stuttgart (DE); Michael Bauer, Gerlingen (DE); Andreas Gruenberger, Spraitbach (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/813,794

(22) PCT Filed: Dec. 21, 2005
(86) PCT No.: PCT/EP05/57047

§ 371 Date: Jul. 12, 2007

(30) Foreign Application Priority Data
Feb. 18, 2005 (DE) 102005007542.8
Jun. 9, 2005 (DE) 102005026514.6

(51) Int. Cl. F02M 51/06

(52) U.S. Cl. 239/585.5

(57) ABSTRACT

An injection nozzle for an internal combustion engine, in particular in a motor vehicle, the nozzle including a nozzle body having at least one injection port, a nozzle needle supported to execute a stroke inside the nozzle body to control an injection of fuel through the at least one injection port, a booster piston that is drive-coupled to an actuator and having a booster surface, the nozzle needle or a needle unit including the nozzle needle having a control surface that is hydraulically coupled to the booster surface. A bypass piston is supported to execute a stroke inside the booster piston, the bypass piston having a bypass surface that is hydraulically coupled to the booster surface, the bypass piston resting against a stop that is stationary in relation to the nozzle body, in an initial state in which the nozzle needle closes the at least one injection port, and the bypass piston having a reservoir surface that delimits a reservoir provided inside the booster piston.

### PRIOR ART

The present invention relates to an injection nozzle for an internal combustion engine, in particular in a motor vehicle, with the defining characteristics of the preamble to claim 1.

An injection nozzle of this kind is known, for example, from DE 103 26 046 A1 and includes a nozzle body that has at least one injection port. A nozzle needle is supported so that it can execute a stroke inside the nozzle body and is able to control an injection of fuel through the at least one injection port. In addition, a booster piston is provided that is drive-coupled to an actuator and has a booster surface. The nozzle needle has a control surface that is hydraulically coupled to the booster surface.

The known injection nozzle functions with a direct needle control. This means that the nozzle needle or a needle unit including the nozzle needle has at least one pressure shoulder that is hydraulically coupled to a supply path that supplies fuel at injection pressure to the at least one injection port. Whereas opening forces can be introduced into the nozzle needle or needle unit by means of the at least one pressure shoulder, closing forces can be introduced into the nozzle needle or needle unit by means of the control surface. When the nozzle needle is closed, the closing forces predominate. In order to open the nozzle needle, the pressure acting on the control surface is reduced, thus reducing the closing forces so that the opening forces predominate. As a result, the nozzle needle lifts up and opens the at least one injection port. The drop in pressure acting on the control surface is achieved through an actuation of the actuator, thus producing a stroke of the booster piston. A hydraulic chamber, which is delimited both by the booster surface and the control surface, is enlarged by the stroke of the booster piston, thus causing a drop in the pressure prevailing therein. A direct needle control of this kind enables short injection times and a dynamic response for the injection nozzle.

Modern injection nozzles must be able to implement both small and large injection quantities as precisely as possible and with the shortest possible injection times. For small injection quantities, it is necessary to keep the opening stroke of the nozzle needle to a minimum in order to be able to return the nozzle needle to the needle seat in a correspondingly rapid fashion with a corresponding closing stroke. For large injection quantities, however, it is necessary for the nozzle needle to execute a relatively large opening stroke as quickly as possible. The stroke of the booster piston that can be executed with the actuator results in a corresponding needle stroke in accordance with the selected ratio between the area of the booster surface and the area of the control surface. A high boosting ratio results in a rapid opening motion of the nozzle needle and a large opening stroke when the actuator is actuated, which is advantageous when implementing large injection quantities with short injection times. A low boosting ratio results in a correspondingly slower opening motion of the nozzle needle and a correspondingly smaller opening stroke when the actuator is actuated. This is advantageous when implementing exactly measured, small injection quantities with short injection times. Known injection nozzles that are able to implement both small injection quantities and large injection quantities consequently have an average boosting ratio as a compromise. In order to nevertheless be able to execute a large opening stroke in spite of a comparatively low boosting ratio, the actuator must be designed to execute a correspondingly large stroke inside the booster piston. This requires the actuator to be comparatively large in volume. But the available installation space in internal combustion engines is limited.

### ADVANTAGES OF THE INVENTION

The injection nozzle according to the invention, with the defining characteristics of the independent claim has the advantage over the prior art of having two different effective boosting ratios, depending on the needle stroke. By contrast, in known injection nozzles, the boosting ratio is constant. A bypass piston is used for this purpose. With a small opening stroke of the nozzle needle, the bypass piston remains against its stop so that the stroke of the booster piston moves only the booster surface. In accordance with the ratio of the area of the control surface to the area of the booster surface, the nozzle needle follows the stroke of the booster piston. With a suitably predetermined opening stroke of the nozzle needle, the forces acting on the bypass surface of the bypass piston are greater than the forces acting on the reservoir surface of the bypass piston. As a result, the bypass piston lifts away from its stop and therefore moves in the same direction as the booster piston. This means that then, during the stroke of the booster piston, both the booster surface and the bypass surface are moved in the same direction. Then the nozzle needle follows the stroke of the booster piston in accordance with the new boosting ratio resulting from the ratio of the area of the control surface to the sum of the areas of the booster surface and bypass surface. This new or second boosting ratio is significantly higher than the first boosting ratio so that the nozzle needle then opens more quickly and can execute a relatively large opening stroke.

The injection nozzle according to the invention can thus trigger the nozzle needle to execute small needle strokes in the range of the first boosting ratio in order to thus implement exact and small injection quantities with short injection times. By means of the second boosting ratio, the injection nozzle according to the invention can also trigger the nozzle needle so that it is possible to execute large needle strokes and therefore implement large injection quantities in comparatively short times. Furthermore, the high second boosting ratio results in the fact that the actuator only needs to execute a relatively small stroke and can therefore be comparatively small.

According to a preferred embodiment, the reservoir can be divided into a first partial reservoir and a second partial reservoir. In addition, a throttle piston is provided, which is drive-coupled to the bypass piston at least in a compressive force-transmitting fashion, is supported so that it can execute a stroke inside the booster piston, and contains a throttle path that hydraulically couples the two partial reservoirs to each other. Furthermore, the reservoir surface is divided into a first partial reservoir surface, which delimits the first partial reservoir and is situated, for example, directly on the bypass piston, and a second partial reservoir surface, which delimits the second partial reservoir and is situated on the throttle piston. This design permits the stroke motion of the bypass piston to be damped in relation to the booster piston, which is accompanied by a damping of the opening motion of the nozzle needle with the higher second boosting ratio. The damped needle motion reduces an excitation of vibrations in the system comprised of the actuator, booster piston, bypass piston, and nozzle needle. This makes the injection process more stable and gives it a reproducible precision. In addition, this avoids a sudden “jumping” of the nozzle needle, i.e. an uncontrolled, sharp speed increase at the transition from the first boosting ratio to the second boosting ratio. This allows the larger needle strokes to still be controlled in a relatively precise fashion.

Other important defining characteristics and advantages of the injection nozzles according to the invention ensue from the dependent claims, the drawings, and the accompanying description of the figures in the drawings.

### DRAWINGS

Exemplary embodiments of the injection nozzle according to the invention are schematically depicted in the drawings and will be explained in detail in the subsequent description; components that are the same or functionally equivalent have been provided with the same reference numerals.

FIG. 1 is a very simplified schematic longitudinal section through an injection nozzle according to the invention,

FIG. 2 is a view similar to the one in FIG. 1 of a detail of the injection nozzle according to the invention, but showing a different embodiment,

FIGS. 3 through 7 are views similar to the one in FIG. 2, but of other different embodiments.

### DESCRIPTION OF THE EXEMPLARY EMBODIMENTS

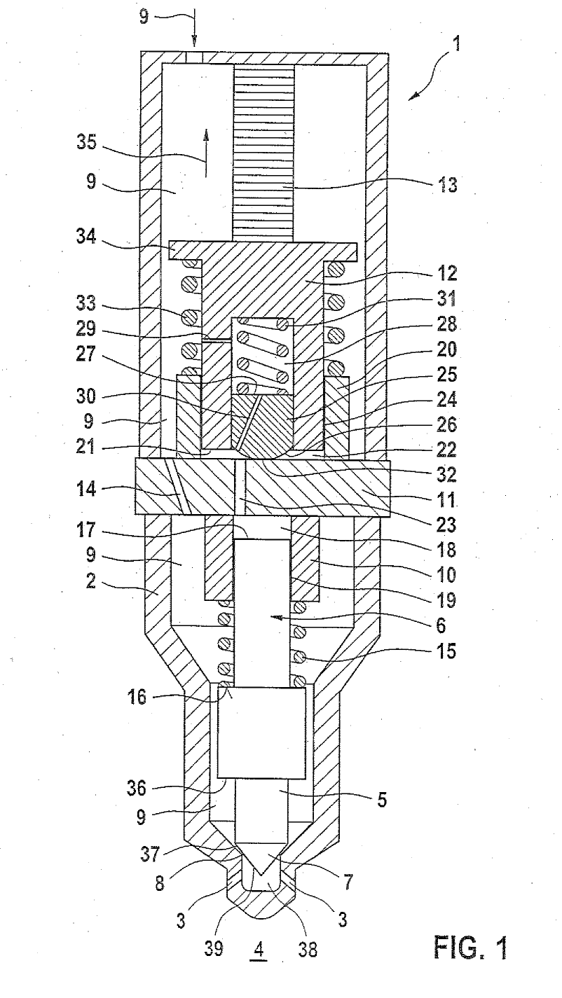

According to FIG. 1, an injection nozzle 1 according to the invention includes a nozzle body 2, which has at least one injection port 3. The injection nozzle 1 is provided for an internal combustion engine, which can in particular be mounted in a motor vehicle, and is used to inject fuel into an injection chamber 4 into which the injection nozzle 1 protrudes in the installed position, at least in the vicinity of the at least one injection port 3.

The injection nozzle 1 includes a nozzle needle 5 that can be part of a needle unit 6 and can be used to control an injection of fuel through the at least one injection port 3. To this end, the needle tip 7 of the nozzle needle 5 cooperates with a needle seat 8. When the nozzle needle 5 is resting against its needle seat 8, the at least one injection port 3 is closed, i.e. the at least one injection port 3 is disconnected from a supply path 9 via which fuel at injection pressure is provided and supplied to the at least one injection port 3.

In the present case, the supply path 9 is routed through the interior of the nozzle body 2 so that the components situated in the nozzle body 2 essentially “float” in the fuel in the supply path 9. It is also fundamentally possible, however, for the supply path 9 to be routed differently.

The nozzle needle 5 or needle unit 6 is supported so that it can execute a stroke inside the nozzle body 2. This support is implemented in this case by means of a first bearing bush 10 into which the end of the needle unit 6 or nozzle needle 5 oriented away from the needle tip 7 is inserted. The first bearing bush 10 is fastened to an intermediate plate 11 that is a component of the nozzle body 2. The intermediate plate 11 thus divides the injection nozzle 1 into a needle region that includes the nozzle needle 5 and a booster region that includes a booster piston 12 and an actuator 13. The supply path 9 is routed through the intermediate plate 11 by means of at least one connecting conduit 14.

A compression-type closing spring 15 presses the nozzle needle 5 or needle unit 6 in the closing direction of the nozzle needle 5. One end of the compression-type closing spring 15 rests against a step 16 of the nozzle needle 5 or needle unit 6 and the other end rests against the first bearing bush 10.

The nozzle needle 5 or its needle unit 6 has a control surface 17 on an end oriented away from the at least one injection port 3. The control surface 17 axially delimits a control chamber 18, which, in addition to being axially delimited by the control surface 17 is also axially delimited by the intermediate plate 11. In addition, the control chamber 18 is radially encompassed by the first bearing bush 10. The control chamber 18 can be hydraulically coupled to the supply path 9 by means of a control chamber path 19. This control chamber path 19 can, for example, be embodied as it is in this instance, in the region of the support between the nozzle needle 5 or needle unit 6 and the first bearing bush 10, e.g. in the form of a bearing clearance or in the form of at least one longitudinal groove that can be provided in the first bearing bush 10 and/or in the nozzle needle 5 or needle unit 6. It is also possible to embody the control chamber path 19 in the form of a cross bore that extends through the first bearing bush 10 and hydraulically connects the control chamber 18 to the supply path 9. The control chamber path 19 is thus throttled.

As explained above, the injection nozzle 1 includes the booster piston 12 that is drive-coupled to the actuator 13. The booster piston 12 is supported so that it can execute a stroke inside the nozzle body 2. To this end, the booster piston 12 is inserted into a second bearing bush 20 that is affixed to the intermediate plate 12. The drive coupling between the booster piston 12 and the actuator 13 results in the fact that a stroke motion of the actuator 13 inevitably produces an identical stroke motion of the booster piston 12. The actuator 13 is suitably embodied in the form of a piezoelectric actuator, which has a larger dimension in the stroke direction when it is supplied with current than when it is not supplied with current.

The booster piston 12 has a booster surface 21 that axially delimits a coupling chamber 22. The booster surface 21 is annular in shape. Axially opposite from the booster surface 21, the coupling chamber 22 is axially delimited by the intermediate plate 11. In addition, the coupling chamber 22 is radially delimited by the second bearing bush 20. The coupling chamber 22 is hydraulically coupled to the control chamber 18 by means of a control path 23. The control path 23 here is implemented in the form of at least one bore that passes through the intermediate plate 11.

The coupling chamber 22 can be hydraulically coupled to the supply path 9 via a coupling chamber path 24. The coupling chamber path 24 can be situated radially between the booster piston 12 and the second bearing bush 20, e.g. in the form of a radial play or in the form of at least one longitudinal groove in the second bearing bush 20 and/or in the booster piston 12. It is likewise fundamentally possible to embody the coupling chamber path 24 in the form of a cross bore that passes through the second bearing bush 20 and connects the coupling chamber 22 to the supply path 9. The coupling chamber path 24 is throttled.

According to the invention, the injection nozzle 1 is also equipped with a bypass piston 25, which is supported so that it can execute a stroke inside the booster piston 12. To this end, the booster piston 12 is embodied in the form of a hollow piston that is open at one end. The bypass piston 25 protrudes into the coupling chamber 22 and has a bypass surface 26 therein that likewise delimits the coupling chamber 22 in a corresponding fashion. On the end oriented away from the bypass surface 26, the bypass piston 25 also has a reservoir surface 27 that delimits a reservoir 28 contained in the booster piston 12.

The booster piston 12 can optionally have at least one throttle 29 that hydraulically couples the reservoir 28 to the supply path 9. Alternatively or in addition, the bypass piston 25 can also contain a throttle 30 that hydraulically couples the reservoir 28 to the coupling chamber 22. A throttle 30 of this kind can also be situated radially between the bypass piston 25 and the booster piston 12, e.g. be embodied in the form of a corresponding radial play and/or in the form of at least one longitudinal groove that is provided in the booster piston 12 and/or in the bypass piston 25.

A return spring 31 axially prestresses the bypass piston 25 against a stop 32. One end of this return spring 31 rests against the booster piston 12 and the other end rests against the bypass piston 25, namely against its reservoir surface 27. The stop 32 is embodied as stationary in relation to the nozzle body 2. In the current instance, the stop 32 is embodied on the intermediate plate 11. The contact between the bypass piston 25 and the stop 32 is suitably embodied so that the bypass surface 26 is as large as possible. In the present case, the contact occurs more or less at a point, which is achieved by means of a convex shape of the bypass piston 25 in the region of its bypass surface 26.

A compression-type opening spring 33 prestresses the booster piston 12 in its opening direction. One end of the compression-type opening spring 33 rests against the second bearing bush 20 and the other end rests against a collar 34 of the booster piston 12.

The volume of the reservoir 28 is suitably greater than the combined volumes of the coupling chamber 22 and control chamber 18.

Although in the embodiment shown here, the coupling chamber 22 and control chamber 18 constitute separate chambers that are connected to each other by means of the control path 23, another embodiment is also possible in which the control chamber 18 and coupling chamber 22 are both contained in a combined chamber.

The injection nozzle 1 according to the present invention functions as follows:

In the initial state shown in FIG. 1, the nozzle needle 5 is resting against the needle seat 8. Consequently, the at least one injection port 3 is closed. The control surface 17 is situated at its greatest distance from the intermediate plate 11. The control chamber 18 is therefore at its greatest volume. The actuator 13 is supplied with current and therefore is at its maximum expansion. As a result, the booster piston 12 has been moved the maximum distance toward the intermediate plate 11. The coupling chamber 22 is thus at its smallest volume. In addition, the bypass piston 25 is resting against the stop 32. In the reservoir 28, the coupling chamber 22, and the control chamber 18, the same pressure prevails as in the supply path 9, i.e. the injection pressure.

In order to execute an injection of fuel through the at least one injection port 3 into the injection chamber 4, the actuator 13 is switched into the currentless state, i.e. the power supply of the actuator 13 is disconnected. The actuator 13 thus operates in reverse fashion. This means that the actuator 13 must be supplied with current in order to close the at least one injection port 3.

When the actuator 13 is switched into the currentless state, it contracts and executes an actuator stroke 35 indicated by an arrow. The booster piston 12 inevitably follows this stroke motion, thus moving away from the intermediate plate 12. On the one hand, this increases the volume of the coupling chamber 22, which is accompanied by a corresponding pressure drop in the coupling chamber 22. On the other hand, this also increases the volume of the reservoir 28 since the bypass piston 25 still remains prestressed against its stop 32. The increase in the reservoir volume is accompanied by a corresponding pressure drop in the reservoir 28.

As a result of the hydraulic coupling between the control chamber 18 and coupling chamber 22, the pressure drop occurring in the coupling chamber 22 immediately spreads to the control chamber 18. As explained above, since the reservoir 28, at least in the initial state, has a greater volume than the total volume of the coupling chamber 22 and the control chamber 18, the pressure in the reservoir 28 decreases more slowly than in the coupling chamber 22 and in the control chamber 18. Consequently, the compressive forces acting on the reservoir surface 27 are greater than the compressive forces acting on the bypass surface 26. As a result, the bypass piston 25 initially remains prestressed against its stop 32.

As the pressure in the control chamber 18 decreases, the forces acting on the nozzle needle 5 in the closing direction also decrease. Starting from a predetermined control pressure, the opening forces engaging the nozzle needle 5 or needle unit 6 are then greater than the effective closing forces. Consequently, the nozzle needle 5 lifts away from the needle seat 8. As a result, the at least one injection port 3 communicates with the supply path 9 and the injection begins.

In order to introduce compressive forces, which act in the opening direction, into the nozzle needle 5 or needle unit 6, the nozzle needle 5 or needle unit 6 is equipped with at least one pressure shoulder 36 or 37 that is/are permanently coupled hydraulically to the supply path 9.

During this first phase of the opening motion, a first boosting ratio prevails between the stroke motion of the booster piston 12 and the stroke motion of the nozzle needle 5. This first boosting ratio is defined at least initially by the ratio of the area of the control surface 17 to the area of the booster surface 21. This first boosting ratio is comparatively low so that a small stroke of the booster piston 12 likewise produces a stroke of the nozzle needle 5 that is comparatively small but can already be greater than the stroke of the booster piston 12. If only a small injection quantity is to be implemented, then within this first phase during which the first boosting ratio is operative, the actuator 13 can be supplied with current again in order to stop the initiated opening motion and reverse it. Whereas the compression-type opening spring 33 intensively assists the opening motion of the booster piston 12, the compression-type closing spring 15 assists the closing motion of the nozzle needle 5.

But if a larger injection quantity is to be implemented, then the currentless state of the actuator 13 is maintained for a longer time so that the booster piston 12 can move farther away from the intermediate plate 11. Consequently, the nozzle needle 5 can also lift farther away from its needle seat 8. As the nozzle needle 5 lifts away from the needle seat 8, an increasing pressure can build up in a chamber 38 from which the at least one injection port 3 leads and which is delimited by a seat surface 39 on the needle tip 7 when the nozzle needle 5 has moved into the needle seat 8. This increases the forces acting on the needle unit 6 in the opening direction, which additionally accelerates the opening motion of the nozzle needle 5. As a result, the volume of the control chamber 18 decreases more rapidly than the volume of the coupling chamber 22 increases. This results in a pressure increase in the control chamber 18 and in the coupling chamber 22. As a result of this pressure increase, starting at an in particular predetermined opening stroke of the nozzle needle 5, the forces acting on the bypass surface 26 of the bypass piston 25 are greater than the forces acting on the reservoir surface 27, namely the return force of the return spring 31 and the compressive force of the pressure prevailing in the reservoir 28. This initiates the second phase of the opening motion.

During this second phase of the opening motion, the bypass piston 25 lifts away from the stop 32 and in particular travels into the reservoir 28. This results in a new value for the boosting ratio between the stroke of the booster piston 12 and the stroke of the nozzle needle 5. The new, second boosting ratio is defined by the ratio of the area of the control surface 17 to the total area of the booster surface 21 and bypass surface 26. The stroke motion of the booster piston 12, together with the stroke movement of the bypass piston 25, thus generates a relatively large stroke motion of the nozzle needle 5. This results in a particularly high opening speed for the nozzle needle 5, thus permitting a comparatively large opening stroke to be implemented. In this case, the high second opening ratio simultaneously permits the stroke of the actuator 13 required for this to remain relatively small so that the actuator 13 and therefore the injection nozzle 1 can therefore be relatively small.

Consequently, in the injection nozzle 1 according to the invention, the control surface 17, the booster surface 21, the bypass surface 26, the reservoir surface 27, the maximum possible actuator stroke, and the maximum possible nozzle needle stroke are matched to one another so that during the stroke motion of the actuator 13 executed to open the nozzle needle 5, the above-mentioned two-phase or two-stage stroke motion for the nozzle needle 5 occurs. During the first phase or first stage, the bypass piston 25 rests against its stop 32. The boosting ratio is relatively low. By contrast, the bypass piston 25 lifts away from its stop 32 during the second phase or second stage. The associated boosting ratio is relatively high.

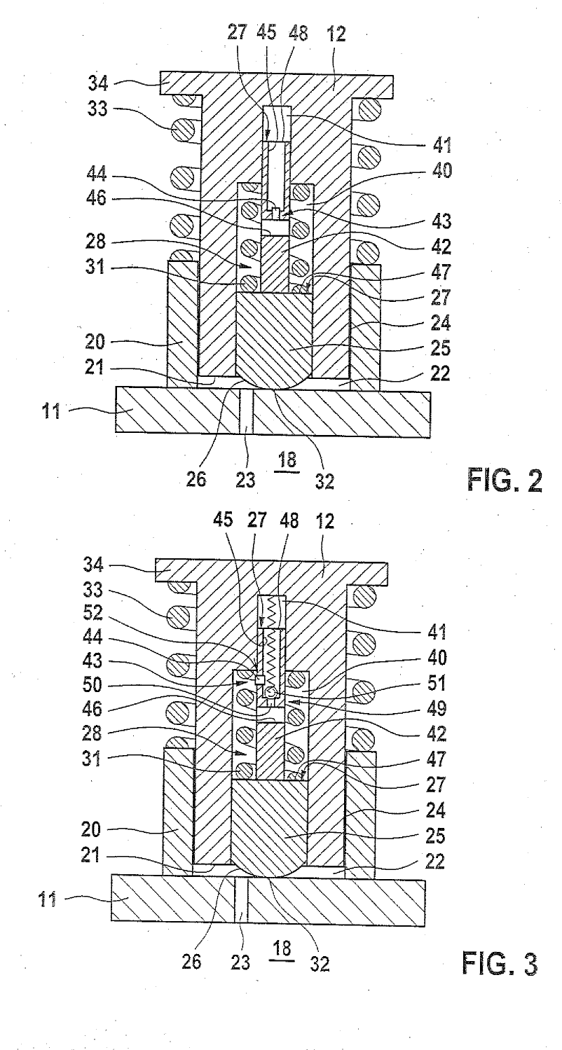

According to FIGS. 2 through 4, it can be suitable to damp the opening motion of the nozzle needle 5 during the second phase, for example in order to avoid an undesirable vibrating behavior of the vibration-prone system comprised of the nozzle needle 5, booster piston 12, and actuator 13. This is achieved through a damping of the stroke motion of the bypass piston 25. In the embodiments shown here, the reservoir 28 is divided for this purpose into a first partial reservoir 40 and a second partial reservoir 41. In addition, a throttle piston 42 is provided, which is drive-coupled to the bypass piston 25 at least in a compressive force-transmitting fashion. The throttle piston 42 is likewise supported so that it can execute a stroke inside the booster piston 12 and contains a throttle path 43 that hydraulically couples the two partial reservoirs 40 and 41 to each other in a throttled fashion.

In the embodiment according to FIG. 2, the throttle path 43 is suitably provided with a throttle 44 that is situated between a longitudinal bore 45 that opens into the second partial reservoir 41 and a cross bore 46 that opens into the first partial reservoir 40. In the embodiments in FIGS. 2 and 3, the throttle piston 42 is attached to the bypass piston 25.

Also in the embodiments in FIGS. 2 through 4, the reservoir surface 27 is divided into a first partial reservoir surface 47 and a second partial reservoir surface 48. The first partial reservoir surface 47, at least in the variants in FIGS. 2 and 3, is provided directly on the bypass piston 25 and delimits the first partial reservoir 40. By contrast, the second partial reservoir surface 28 is provided on the throttle piston 42 and delimits the second partial reservoir 41.

In the variant according to FIG. 2, the movement of the bypass piston 25 into the reservoir 28 is throttled because in order for this movement to occur, fuel must be displaced from the second partial reservoir 41, through the throttle path 43, and into the first partial reservoir 40.

The embodiment according to FIG. 3 differs from the one according to FIG. 2 in that the path end of the throttle path 43 is situated radially on the throttle piston 42. The throttle 44 in this case constitutes this path end. In addition, the throttle piston 42 contains a bypass path 49, which in this case, is implemented in the form of a connecting bore 50 between the longitudinal bore 45 and the cross bore 46. The bypass path 49 consequently bypasses the throttle path 43 and in this case, is also equipped with a check valve 51 that closes when the throttle piston 42 moves inward into the second partial reservoir 41.

In the embodiment according to FIG. 33 the throttle path 43 is also controlled as a function of the throttle piston stroke. As the bypass piston 25 moves inward into the reservoir 28, first the fuel volume is displaced from the second partial reservoir 41, through the throttle path 43, and into the first partial reservoir 40. The check valve 51 closes the connecting bore 50 during this movement. After a particular amount of inward stroke, a control edge 52 of the booster piston 12 travels past the above-mentioned path end, in this case the throttle 44, thus closing the throttle path 43.

When the bypass piston 25 moves out of the reservoir 28, the check valve 51 opens, thus opening the bypass path 49 and allowing the throttle path 43 to be bypassed. The outward motion of the bypass piston 25 is therefore unthrottled and is in addition assisted by the return spring 31. As a result, the initial state can be reached relatively quickly and the nozzle needle 5 can be returned to its seat 8 with relative speed. The closing process for terminating the injection can therefore be triggered with relative speed and precision.

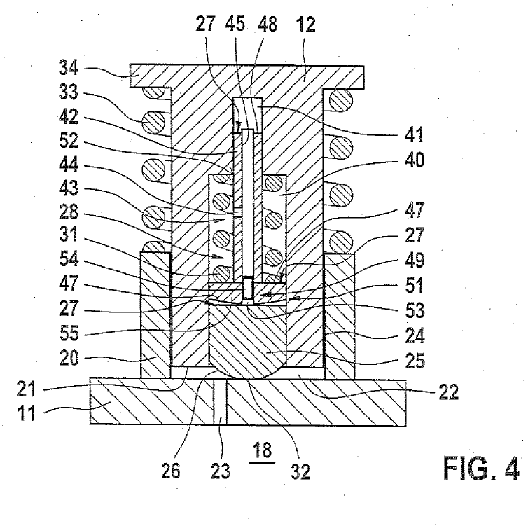

The embodiment according to FIG. 4 likewise has a throttle path 43 controlled by the throttle piston stroke as well as a bypass path 49 equipped with a check valve 51. The embodiment according to FIG. 4 differs from the one according to FIGS. 2 and 3 in that the throttle piston 42 and the bypass piston 25 are separate components that only rest against each other loosely. In this case, the return spring 31 drives the throttle piston 42 and by means of it, the bypass piston 25. In this case, the bypass path 49 has an axial opening end 53 that is closed when there is an axial contact between the bypass piston 25 and throttle piston 42. When the bypass piston 25 moves inward into the reservoir 28, it rests against the throttle piston 42 and drives it to travel inward into the second partial reservoir 41. Since the bypass path 49 is closed in this instance, the throttle path 43 is active and the inward motion of the bypass piston 25 is throttled. In order to move outward, the bypass piston 25 can lift away from the throttle piston 42, thus opening the bypass path 49. The bypass piston 25 can therefore move outward and assume its initial position in contact with the stop 32 in a comparatively quick, undamped fashion. The throttle piston 42 follows it, driven by the return spring 31. The bypass path 49 can contain an additional throttle 54.

In the embodiment according to FIG. 4, the check valve 51 is constituted by the cooperation between the bypass piston 25 and the throttle piston 42. In the embodiment according to FIG. 4, the first partial reservoir surface 47 is inherently provided on the bypass piston 25. Depending on the tightness with which a head 55 of the throttle piston 42 rests against the bypass piston 25, this first partial reservoir surface 47 can likewise be provided on this head 55.

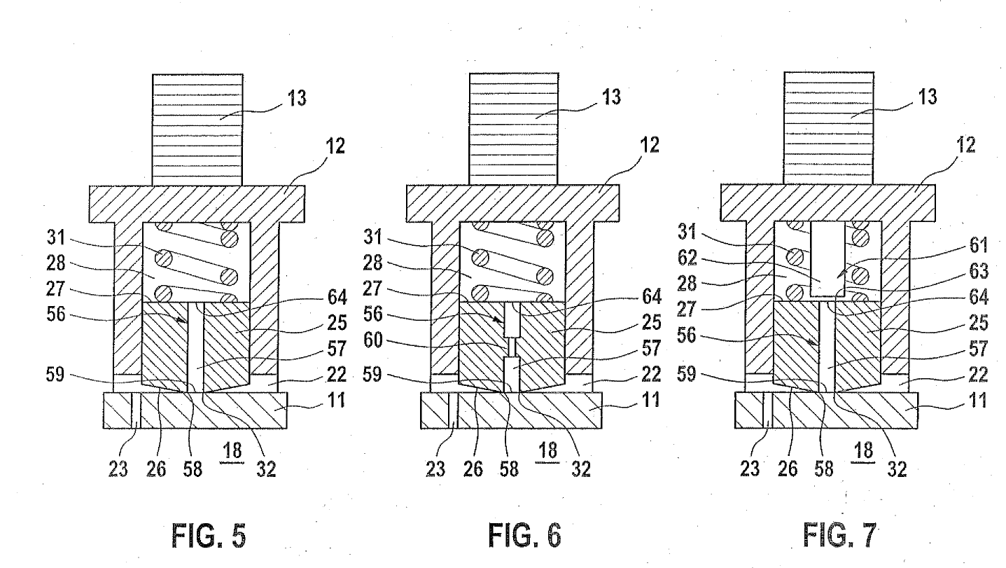

According to FIGS. 5 through 7, the injection nozzle 1 can also be equipped with a bypass path 56 in the region of the bypass piston 25. In the exemplary embodiment shown here, this bypass path 56 is embodied in the form of a bypass conduit 57, which passes through the bypass piston 25 from the reservoir surface 27 to the bypass surface 26 and is in particular situated coaxial to this bypass piston 25. Alternatively, the bypass path 56 or bypass conduit 57 can also be shaped and situated in any other way. For example, the bypass path 56 can be comprised of a bypass conduit 57 situated diagonally inside the bypass piston 25. When the bypass piston 25 is lifted away from the stop 32, the bypass path 56 or bypass conduit 57 produces a hydraulic coupling between the reservoir surface 27 and the bypass surface 26 and therefore between the reservoir 28 and the coupling chamber 22. In addition, the bypass path 56 is embodied so that it is closed when the bypass piston 25 is resting against the stop 32. The closing action of the bypass path 56 in the initial state of the bypass piston 25, i.e. when the bypass piston 25 is resting against the stop 32, is achieved in the preferred embodiments shown here by virtue of the fact that the bypass surface 26 of the bypass piston 25 has an annular sealing zone 58. The sealing zone 58 encompasses an opening 59 of the bypass conduit 57, which opening is associated with and/or situated in the bypass surface 26. In the initial state, the bypass piston 25 rests with its sealing zone 58 against the stop 32. The sealing zone 58 thus closes the bypass path 56 off from the coupling chamber 22 in a sealed fashion. By contrast with the central location of the bypass conduit 57 in FIGS. 5 through 7, in a different embodiment, the bypass piston 25 and/or intermediate plate 11 can be embodied in such a way that the sealing surface 58 is situated at any other diameter, e.g. on the outer diameter of the bypass piston 25.

According to FIG. 6, the bypass path 56 can be throttled. For example, the throttle path 56 contains a throttle 60 for this purpose. In the present instance, the throttle 60 is situated in the bypass conduit 57.

According to FIG. 7, the bypass path 56 can optionally be embodied so that it is closed at or after a predetermined bypass stroke of the bypass piston 25 during which the bypass piston 25 moves inward into the reservoir 28. In this instance, this is achieved, for example, by means of a reservoir shutoff valve 61 that closes the bypass path 56, in this case the bypass conduit 57, once the predetermined bypass stroke has been reached. To this end, the reservoir valve 61 has a valve member 62, for example, that cooperates with a circular valve seat 63. The valve seat 63 is provided on the bypass piston 25, namely on its reservoir surface 27. In this case, the valve seat 63 encompasses an opening 64 of the bypass conduit 57 that is associated with, i.e. situated in, the reservoir surface 27. Once the predetermined bypass stroke has been reached, the valve member 62 travels into its valve seat 63 and closes the above-mentioned opening 64 of the bypass conduit 57 in a sealed fashion. The valve member 62 in this case is equipped, for example, with a flat end surface; the valve seat 63 is shaped in a complementary fashion. Alternatively, the valve member 62 can also be embodied in any other suitable form, e.g. a conical or spherical form; the valve seat 63 is then shaped in a respectively complementary fashion.

It is clear that the individual defining characteristics of the embodiments according to FIGS. 5 through 7 can be combined in virtually any fashion with the defining characteristics of the embodiments in FIGS. 1 through 4.

During nonstationary operating states, particularly in connection with an increasing fuel pressure in the supply path 9, it is fundamentally possible for the pressure in the coupling chamber 22 to increase to such a degree that the bypass piston 25 lifts away from the stop 32 although the actuator 13 has not yet been triggered to execute an opening stroke. This is due, for example, to the relative compressibility of the hydraulic volume enclosed in the comparatively large reservoir 28. If the injection nozzle 1 is actuated to execute an injection when the bypass piston 25 is lifted away from the stop 32, then during the opening stroke of the booster piston 12, the second boosting ratio is operative from the beginning, which ratio causes the booster piston 12 to be pulled away from the actuator 13 at a high speed but with a low force. This can considerably reduce the precision of the injection with regard to the quantity of fuel injected. At the same time, the bypass piston 25 could move in the opposite direction due to the changing pressure ratios, as a result of which the required pressure drop in the coupling chamber 22 would not occur or would only occur in a delayed fashion. In the extreme case, the nozzle needle 5 would remain closed.

The bypass path 56 provided in the embodiments in FIGS. 5 through 7 can remedy this because as soon as the increasing pressure in the coupling chamber 22 during corresponding nonstationary operating states causes the bypass piston 25 to lift away from the stop 32, a pressure compensation between the reservoir 28 and the coupling chamber 22 occurs by means of the bypass path 56. The return spring 31 can then move the bypass piston 25 back into the initial position in which it rests against the stop 32. This assures that with an opening actuation of the actuator 13, the bypass piston 25 initially rests against the stop 32 so that at the beginning of the opening movement, the first boosting ratio is operative, which ratio causes the booster piston 12 to be pulled away from the actuator 13 slowly and therefore with a powerful force.

The throttle 60 or the throttling action of the bypass path 56 is provided so that with the desired changeover from the first boosting ratio to the second boosting ratio, the pressure compensation between the coupling chamber 22 and reservoir 28 occurs in a throttled fashion to a degree that allows the bypass piston 25 to properly lift away from the stop 32 and remain lifted for the duration of the injection.

The reservoir shutoff valve 61 is thus able to assure that for the second phase or second stage of the needle opening, the pressure compensation between the coupling chamber 22 and reservoir 28 is terminated once the bypass stroke of the bypass piston 25 has been reached. This also makes it possible to avoid a premature return of the bypass piston 25 to its stop 32.

### REFERENCE NUMERAL LIST

1 injection nozzle
2 nozzle body
3 injection port
4 injection chamber
5 nozzle needle
6 needle unit
7 needle tip
8 needle seat
9 supply path
10 first bearing bush
11 intermediate plate
12 booster piston
13 actuator
14 connecting conduit
15 compression-type closing spring
16 shoulder between 5 and 6
17 control surface
18 control chamber
19 control chamber path
20 second bearing bush
21 booster surface
22 coupling chamber
23 control path
24 coupling chamber path
25 bypass piston
26 bypass surface
27 reservoir surface
28 reservoir
29 throttle
30 throttle
31 return spring
32 stop
33 compression-type opening spring
34 collar
35 actuator stroke
36 pressure shoulder
37 pressure shoulder
38 chamber
39 seat surface
40 first partial reservoir
41 second partial reservoir
42 throttle piston
43 throttle path
44 throttle
45 longitudinal bore
46 cross bore
47 first partial reservoir surface
48 second partial reservoir surface
49 bypass path
50 connecting bore
51 check valve
52 control edge
53 opening end of 49
54 throttle
55 head of 42
56 bypass path
57 bypass conduit
58 sealing zone
59 opening of 57
60 throttle
61 reservoir shutoff valve
62 valve member
63 valve seat
64 opening of 57

1-10. (canceled)

11. An injection nozzle for an internal combustion engine, in particular in a motor vehicle, the injection nozzle comprising
a nozzle body having at least one injection port,
a nozzle needle supported for execution of a stroke inside the nozzle body for controlling an injection of fuel through the at least one injection port,
an actuator,
a booster piston drive-coupled to an actuator and having a booster surface thereon,
the nozzle needle or a needle unit including the nozzle needle having a control surface hydraulically coupled to the booster surface,
a bypass piston supported so that it is able to execute a stroke inside the booster piston,
a bypass surface on the bypass piston hydraulically coupled to the booster surface,
the bypass piston resting against a stop that is stationary in relation to the nozzle body in an initial state in which the nozzle needle closes the at least one injection port, and
a reservoir surface on the bypass piston that delimits a reservoir inside the booster piston.

12. The injection nozzle according to claim 11, wherein the booster surface delimits a coupling chamber, wherein the control surface delimits a control chamber, and wherein the coupling chamber and control chamber are embodied either as separate chambers that are hydraulically connected to each other by means of a control path or are embodied as a combined chamber.

13. The injection nozzle according to claim 12, wherein the volume of the reservoir is greater than the combined volume of the coupling chamber and control chamber.

14. The injection nozzle according to claim 11, wherein the bypass surface delimits a coupling chamber, which is also delimited by the booster surface, and/or the control surface, the booster surface, the bypass surface, the reservoir surface, the maximum possible actuator stroke, and the maximum possible nozzle needle stroke are matched to one another so that during a stroke motion of the actuator executed to open the nozzle needle, a two-phase stroke motion for the nozzle needle occurs in which the bypass piston rests against the stop during a first stage and moves away from the stop during a second stage.

15. The injection nozzle according to claim 12, wherein the bypass surface delimits a coupling chamber, which is also delimited by the booster surface, and/or the control surface, the booster surface, the bypass surface, the reservoir surface, the maximum possible actuator stroke, and the maximum possible nozzle needle stroke are matched to one another so that during a stroke motion of the actuator executed to open the nozzle needle, a two-phase stroke motion for the nozzle needle occurs in which the bypass piston rests against the stop during a first stage and moves away from the stop during a second stage.

16. The injection nozzle according to claim 13, wherein the bypass surface delimits a coupling chamber, which is also delimited by the booster surface, and/or the control surface, the booster surface, the bypass surface, the reservoir surface, the maximum possible actuator stroke, and the maximum possible nozzle needle stroke are matched to one another so that during a stroke motion of the actuator executed to open the nozzle needle, a two-phase stroke motion for the nozzle needle occurs in which the bypass piston rests against the stop during a first stage and moves away from the stop during a second stage.

17. The injection nozzle according to claim 11, further comprising a throttle piston, and wherein the reservoir is divided into a first partial reservoir and a second partial reservoir, wherein the throttle piston is drive-coupled to the bypass piston at least in a compressive force-transmitting fashion, is supported so that it is able to execute a stroke inside the booster piston, and includes a throttle path that hydraulically couples the two partial reservoirs, and wherein the reservoir surface is divided into a first partial reservoir surface, which delimits the first partial reservoir, and a second partial reservoir surface, which delimits the second partial reservoir and is situated on the throttle piston.

18. The injection nozzle according to claim 12, further comprising a throttle piston, and wherein the reservoir is divided into a first partial reservoir and a second partial reservoir, wherein the throttle piston is drive-coupled to the bypass piston at least in a compressive force-transmitting fashion, is supported so that it is able to execute a stroke inside the booster piston, and includes a throttle path that hydraulically couples the two partial reservoirs, and wherein the reservoir surface is divided into a first partial reservoir surface, which delimits the first partial reservoir, and a second partial reservoir surface, which delimits the second partial reservoir and is situated on the throttle piston.

19. The injection nozzle according to claim 13, further comprising a throttle piston, and wherein the reservoir is divided into a first partial reservoir and a second partial reservoir, wherein the throttle piston is drive-coupled to the bypass piston at least in a compressive force-transmitting fashion, is supported so that it is able to execute a stroke inside the booster piston, and includes a throttle path that hydraulically couples the two partial reservoirs, and wherein the reservoir surface is divided into a first partial reservoir surface, which delimits the first partial reservoir, and a second partial reservoir surface, which delimits the second partial reservoir and is situated on the throttle piston.

20. The injection nozzle according to claim 14, further comprising a throttle piston, and wherein the reservoir is divided into a first partial reservoir and a second partial reservoir, wherein the throttle piston is drive-coupled to the bypass piston at least in a compressive force-transmitting fashion, is supported so that it is able to execute a stroke inside the booster piston, and includes a throttle path that hydraulically couples the two partial reservoirs, and wherein the reservoir surface is divided into a first partial reservoir surface, which delimits the first partial reservoir, and a second partial reservoir surface, which delimits the second partial reservoir and is situated on the throttle piston.

21. The injection nozzle according to claim 17, wherein the throttle path contains a throttle, and wherein the throttle piston contains a bypass path that bypasses the throttle and has a check valve that closes when the throttle piston moves inward into the second partial reservoir.

22. The injection nozzle according to claim 18, wherein the throttle path contains a throttle, and wherein the throttle piston contains a bypass path that bypasses the throttle and has a check valve that closes when the throttle piston moves inward into the second partial reservoir.

23. The injection nozzle according to claim 19, wherein the throttle path contains a throttle, and wherein the throttle piston contains a bypass path that bypasses the throttle and has a check valve that closes when the throttle piston moves inward into the second partial reservoir.

24. The injection nozzle according to claim 20, wherein the throttle path contains a throttle, and wherein the throttle piston contains a bypass path that bypasses the throttle and has a check valve that closes when the throttle piston moves inward into the second partial reservoir.

25. The injection nozzle according to claim 21, wherein the bypass piston and the throttle piston are separate components, wherein when the bypass piston is traveling inward into the first partial reservoir, it rests against and drives the throttle piston to travel inward into the second partial reservoir, wherein
when the bypass piston is driving the throttle piston to travel inward into the second partial reservoir, it closes an opening end of the bypass path, and wherein when the bypass piston is traveling outward from the first partial reservoir, it lifts away from the throttle piston and opens the opening end of the bypass path.

26. The injection nozzle according to claim 17, wherein the throttle path is controlled as a function of the throttle piston stroke and/or the throttle path has a path end that is situated radially on the throttle piston, and wherein order to close the throttle path, the throttle piston travels inward into the second partial reservoir until a control edge provided on the booster piston travels past the path end.

27. The injection nozzle according to claim 21, wherein the throttle path is controlled as a function of the throttle piston stroke and/or the throttle path has a path end that is situated radially on the throttle piston, and wherein order to close the throttle path, the throttle piston travels inward into the second partial reservoir until a control edge provided on the booster piston travels past the path end.

28. The injection nozzle according to claim 25, wherein the throttle path is controlled as a function of the throttle piston stroke and/or the throttle path has a path end that is situated radially on the throttle piston, and wherein order to close the throttle path, the throttle piston travels inward into the second partial reservoir until a control edge provided on the booster piston travels past the path end.

29. The injection nozzle according to claim 11, further comprising a bypass path which hydraulically couples the reservoir surface to the bypass surface when the bypass piston is lifted away from the stop and is closed when the bypass piston is resting against the stop.

30. The injection nozzle according to claim 29, wherein the bypass path is constituted by a bypass conduit that passes through the bypass piston from the reservoir surface to the bypass surface, and/or the bypass surface of the bypass piston has an annular sealing zone with which the bypass piston rests against the stop in the initial state and which encompasses an opening of the bypass conduit, which opening is associated with the bypass surface and/or the bypass path and/or the bypass conduit is throttled or contains a throttle, and/or
the bypass path and/or the bypass conduit is closed at or after a predetermined bypass stroke of the bypass piston has been reached as it travels inward into the reservoir, and/or
a reservoir shutoff valve closes the bypass path and/or the bypass conduit when the bypass stroke has been reached, and/or a valve member of the reservoir shutoff valve cooperates with a circular valve seat, which is situated on the reservoir surface and encompasses an opening of the bypass conduit, which opening is associated with the reservoir surface.
